(19) United States
(12) Patent Application Publication
(10) Pub. No.: US 2018/0231108 A1
(43) Pub. Date: Aug. 16, 2018

(54) Continuously Variable Transmission with Fragmentary pulleys and a Plain Belt

(71) Applicant: Benyamin Akbari Rostami, Vancouver (CA)

(72) Inventor: Benyamin Akbari Rostami, Vancouver (CA)

(21) Appl. No.: 15/434,066

(22) Filed: Feb. 16, 2017

(51) Int. Cl. F16H 9/10; F16H 55/54

(52) U.S. Cl. CPC F16H 9/10; F16H 55/54

(57) ABSTRACT

This new mechanism can effect a smooth change in speed ratio of a variety of machines, namely, in those of automobile gear boxes, motorcycles, bicycles or generally any system that is designed for transferring power which is subject to change in ratio. This idea, however, consists of a pulley that is capable of changing ratio without needing to halt or going through a step-off phase. This pulley, which I call Fragmentary pulley for argument's sake, is made up of, 10, 20, 24, 36 fragments. These fragments can move on path toward the center of the pulley and vice versa, thus varying the diameter of the pulley. In other words, the change in ratio will occur as result of this movement. The aforementioned process is the very foundation of my fragmentary pulley, though. the addition of another pulley with the same structure, spinning the opposite direction, augments the whole process. In short, when the input pulley is working with the smallest diameter, the secondary pulley will be working with its biggest diameter. In other words, the greater speed causes the input pulley to expand and the output pulley to contract.

### BACKGROUND

Applying simple geometric rules, we can detach the joints of cylinders and connect them where they meet with the base, using hinges. Such a combination renders the cylinders mobile on their base, thus making it possible for them to change the diameter accordingly. I have factored in many advantages which have inclined me to use this mechanism, some of which have been adumbrated as follow. The manufacturability of this mechanism without high technology, Flexibility in design, the ability to be easily modified with minor changes, Utility across a wide range of application, cost effective and economical, it is easy to maintain the system. One good thing is that we can include a package which is specifically developed for gear boxes. However, in order for this system to operate properly, we will need a command control, which is easy to develop. Similarly, not only do we need to delineate the boundary in which sun move, but we also need to find a way to offset the abrupt shocks that are bound to throw off the system. Yet we have to understand addressing such problems call for a standard procedure, nothing out of the ordinary.

### TECHNICAL FIELD

This invention relates to continuously variable transmission.

### BACKGROUND

It is known to use a continuously variable transmission for various applications.

### SUMMARY

This new invention brings to mind the very innovating idea of a wheel, which has been part and parcel of every rotating system as it has propelled science and technology forward for thousands of years despite having been grounded in simple geometrical rules. Similarly, the concept of a fragmentary pulley can be used in a variety of systems due to its simplicity and efficiency. There is certainly more to fragmentary pulley system than meets the eye, as it could go a long way toward resolving many issues that have hitherto remained unresolved in different fields of study. Let's consider a hollow cylinder which has, at its base, been divided to any even numbers over two. Now if we remove all odd numbers, or even numbers, cutting off points on the bases of the cylinder to equal corresponding parts, by removing the same corresponding even or odd parts, we can create 4 hinged joints on each of these parts; a two-point junction to the base of the cylinder, and a 2-point junction in any desired location on the same base. The outward movements of the cylindrical legs cause the circumference and the cylindrical lateral surface to reduce. In other words, we have two truncated cones and a cylinder on either side of the lateral surface, but it will be smaller in diameter. We would call this phenomenon “fragmentary wheel” and by extension we would call this specific project as “Fragmentary Pulley.” The characteristics of the fragmentary wheels are such that they can be utilized in many different fields such as automobile transmission. However, I have focused on their use in automobile gearbox and thus called it “Continuously Variable Fragmentary Pulley”. “The FIG. 18 is describing of this paragraph”

The driving force generated by the engine(1) or any other power-producing machine can then be transmitted to the control box(3), by the shaft(2). In this control box(3) the input force will be processed and the appropriate force will enter the fragmentary pulley system(5). At this time, the machine's control system(6) will start to calculate the information according to end users(9,10) and the input force will also accelerate to find the best position for the pulleys (11,22). Based on this calculation the control system commands the sun (12,13,14,15) to move to appropriate positions. Consequently, the positioning of the sun (12,13,14,15) will cause the pulleys (11,22) to create the optimal ratio to be delivered to the output shaft (7), the differential and other end users (9,10).

The necessary torque enters the first pulley (11) and the fragmentary pulley system (5), through the input shaft (4). As noted in FIG. 1, the control system (6), based on its calculation, sends a certain command to suns (12,13,14,15). The axial movements of suns (12,13) on the input axis of shaft (4) and conversely the axial movement of suns (14,15) on output shaft (7) causes the diagonal retaining bars (16,17,18,19) to move; this movement, in turn, causes the movement of headpieces which are the seats of the belt (20,21). In fact, the movement of V-shape headpieces (20,21) which are sitting on diagonal retaining bars toward the center of the pulley or vice versa effects a change in the diameter of the pulley and maintains the desired ratio.

The following blown-up diagram shows the components of a fragment pulley system the way they are installed. Input pulley (11) Input shaft (4) The suns of the input pulley (12,13) joint pins (24,25) Diagonal retaining bars (16,17) The joint pins (26) The connecting pins for diagonal retaining bars. Input pulley grooves, holding the belt (20) Output pulley (22) Output shaft (7) Output pulley suns (14,15) The joint pins (28,29) The connecting pins (18,19) Output suns. The diagonal retaining bars (18,19) The joint pins (27) The connecting pins for diagonal retaining bars (19,18) The aggregate of V-shape headpieces which make up the groove the belt sits on. (20,21)

This diagram shows the fragmentary pulley system from different angles and an isometric view as well. In this diagram the input pulley (11) is at its widest circumference and the output pulley (22) is at its narrowest circumference. The limiting ridges on shaft (4,7) limit the movements of the suns within logical distances.

This diagram demonstrates the input pulley (11) individually from 3 different angles and also an isometric view of it. The input pulley is at its smallest circumference and the suns are at their dead end limit on their shaft. These large scale figures can help us to understand the workings of our pulley system better.

This diagram demonstrates the output pulley (22) individually from 3 different angles and also the isometric view of it. The output pulley is at its largest circumference. These large scale figures can help us to understand the workings of our pulley system better.

FIG. (7) is a blown-up diagram of input pulley which clearly demonstrates the placement of different components on the shaft and the aggregate of V-shape headpieces (20) which make up the groove the belt sits on.

One of the most advantageous feature in this system is the capability and ease with which you can combine a pair of pulleys to incorporate them into a compound system. These pairs could be daisy chained together. The following illustration (8) shows a serially connected compound where the driving force in the form of torque enters the input pulley via shaft (4). The torque is then transferred to the output pulley (22) by the belt (23). Subsequently, the force enters pulley 11 through the integrated shaft (30). The force is then transferred to the output pulley 22 by means of belt 23. Finally, the output shaft 7 delivers the appropriate ratio to end users. The serially connected compound systems can easily be modified to create a great range of ratio variables in numerous machines.

Diagram 9 illustrates three different views of V-Shaped pieces which holistically create the groove where the belt sits on. We can devise a variety of head pieces for different purposes. Each of these V-shaped head pieces are connected to diagonal retaining bars 16 by means of a pin. These V-shaped headpieces move toward the center of the pulley with the movements of these diagonal retaining bars widening or narrowing the circumference of the aggregate V-shape headpieces which are to take the belt. We can design a variety of materials for the belt according to the required friction between the belt and the V-shape headpieces.

Diagram 10 shows a front and side view of a diagonal retaining bar 16 along with an isometric view of it. On one end of them, these diagonal retaining bars are connected to the sun 12, while on the other end they are hinged on to the headpieces which create a V-shape pulley. We can easily modify the range of movement by shortening or lengthening the diagonal retaining bars (16) accordingly.

Diagram 11 illustrates front, top and isometric views of a sun. The function of the suns is, initially to grip the diagonal retaining bars and to secondly move axially on their shafts and cause the appropriate diameter in the pulley.

The suns and the diagonal retaining bars are hinged together. We can vary the designs to create special suns for a variety of purposes.

As was previously discussed, with minor changes in the design of pulleys, we can devise different pulley types for different purposes. We can either increase the number of V-shaped headpieces as in (FIG. 12) or we can decrease the number of V-shaped headpieces as in FIG. 13. Not only can we lengthen the diagonal retaining bars as in FIG. 14 but we can also shorten the diagonal retaining bars as in FIG. 15. Conversely, we can lengthen the diagonal retaining bars, shorten the diameter of the sun and increase the number of headpieces as in FIG. 16. These are only a few examples that enlarge upon the flexibility factor in an ingenious design that employs simple mathematical rules.

In this diagram (17) two different types of shafts have been indicated; shaft 30 which is a one-piece shaft placed between two pulleys (11,12). This type of shaft can be used in a compound fragmentary pulley system which is arranged in series (illustrated in FIG. 8). The torque enters through the output pulley (22) by means of this shaft, and then it is transferred to the input pulley (11). You can get a full appreciation of these variations by comparing the long shaft 30 and the short shafts (4,7) in the following diagram.

### BRIEF DESCRIPTION OF THE DRAWINGS

FIG. 1 is a schematic diagram showing the location of the power transferring.

FIG. 2 shows the assembly of the whole fragmentary pulley system along with its belt.

FIG. 3 is a blow-up representation of the fragmentary pulley system and its belt.

FIG. 4 shows isometric, front and side views of a fragmentary pulley system with their input and output shafts.

FIG. 5 shows the assemblage of one fragmentary pulley at its smallest circumference.

FIG. 6 shows the assemblage of one fragmentary pulley at its greatest circumference.

FIG. 7 is a blown-up diagram of one fragmentary pulley.

FIG. 8 illustrates the workings of two pairs of pulleys assembled in a series fashion.

FIG. 9 shows the isometric, front and side views of the V-shape headpiece that is to take the belt.

FIG. 10 shows the isometric, front and side views of the angled retaining bar.

FIG. 11 shows the isometric, front and side views of the sun.

FIG. 12-16 illustrates 5 variations in the fragmentary pulleys and how we can modify the system to fit different purposes by effecting minor changes.

FIG. 17 illustrates two different types of shafts with the longer shaft being used in a series compound pulley system.

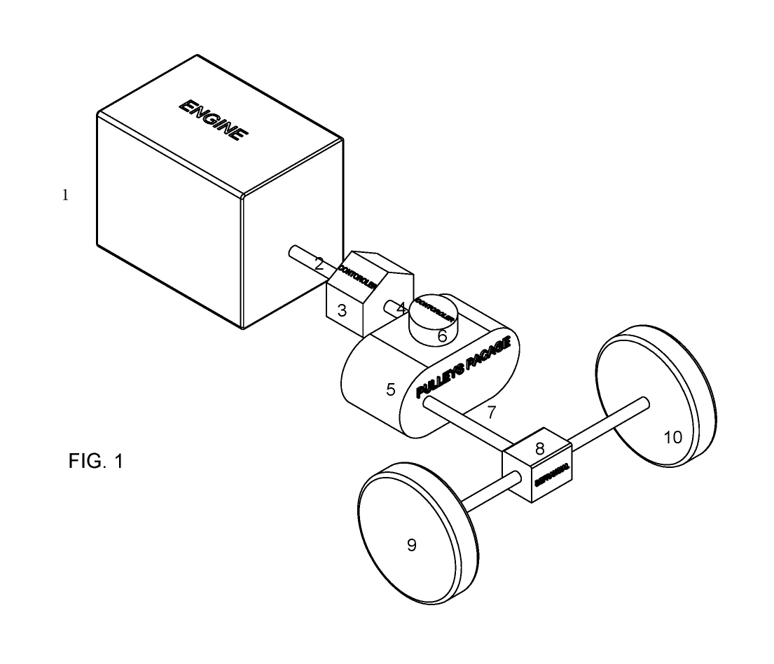

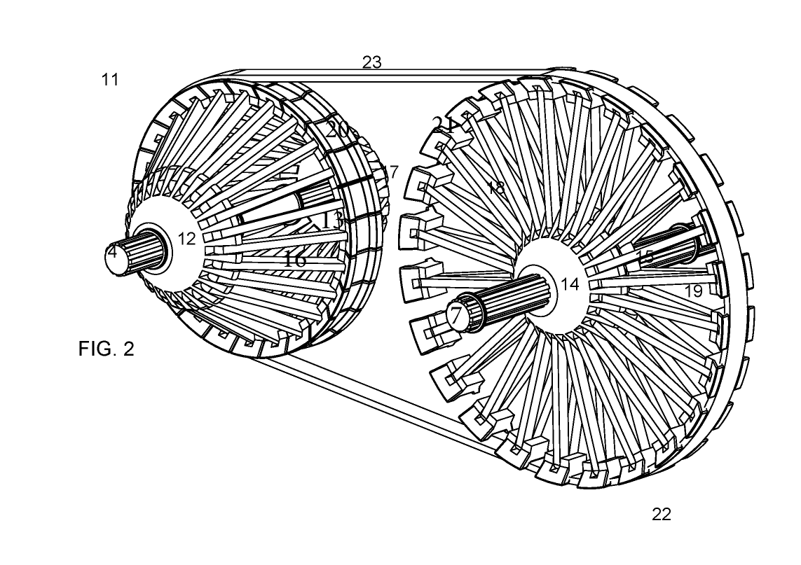

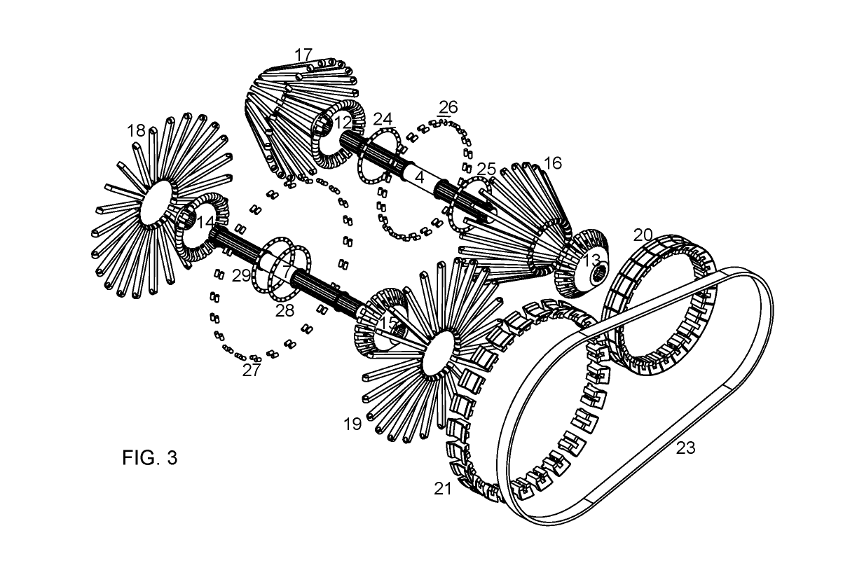

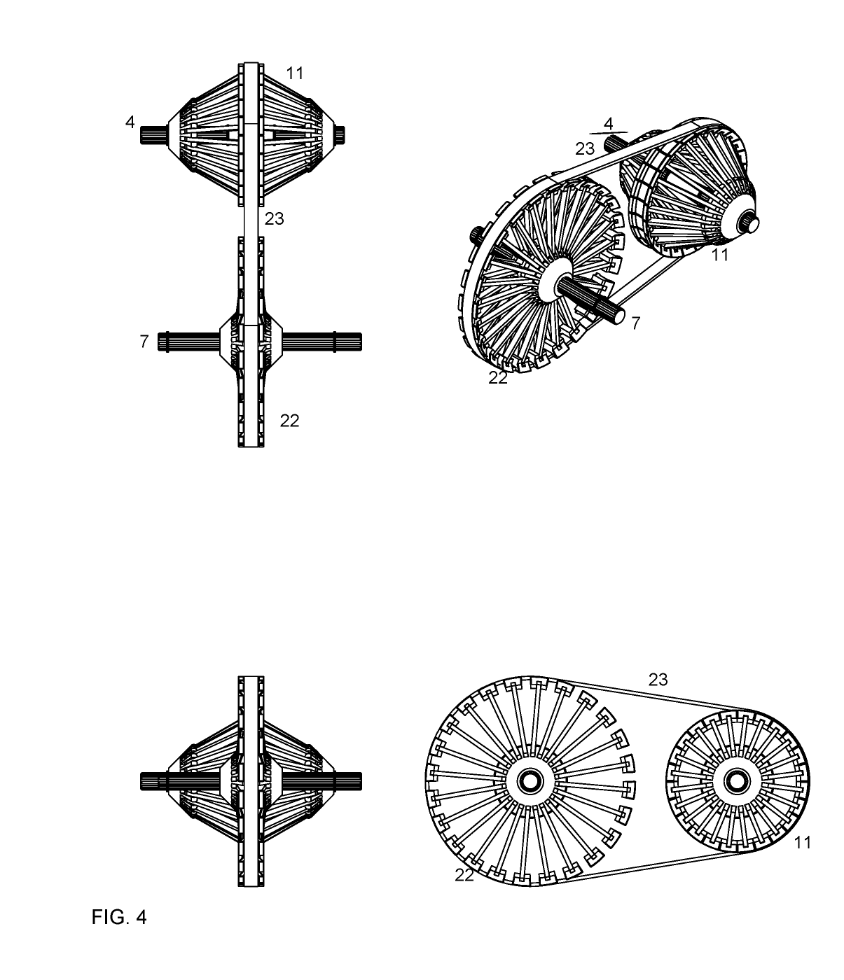

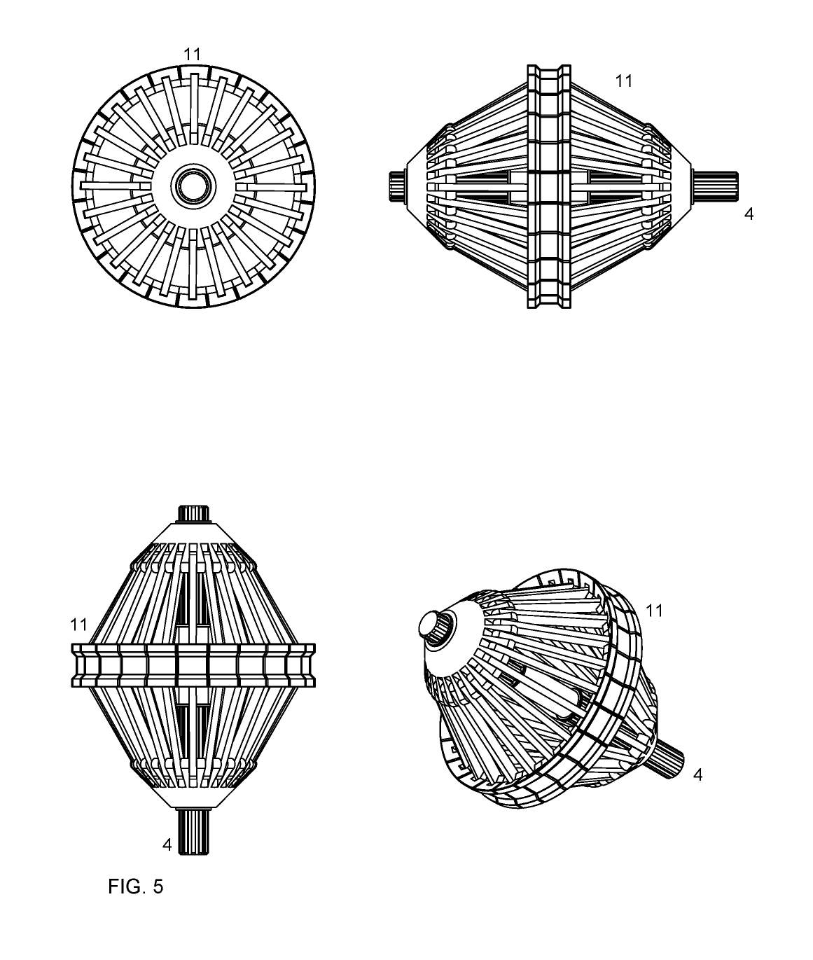

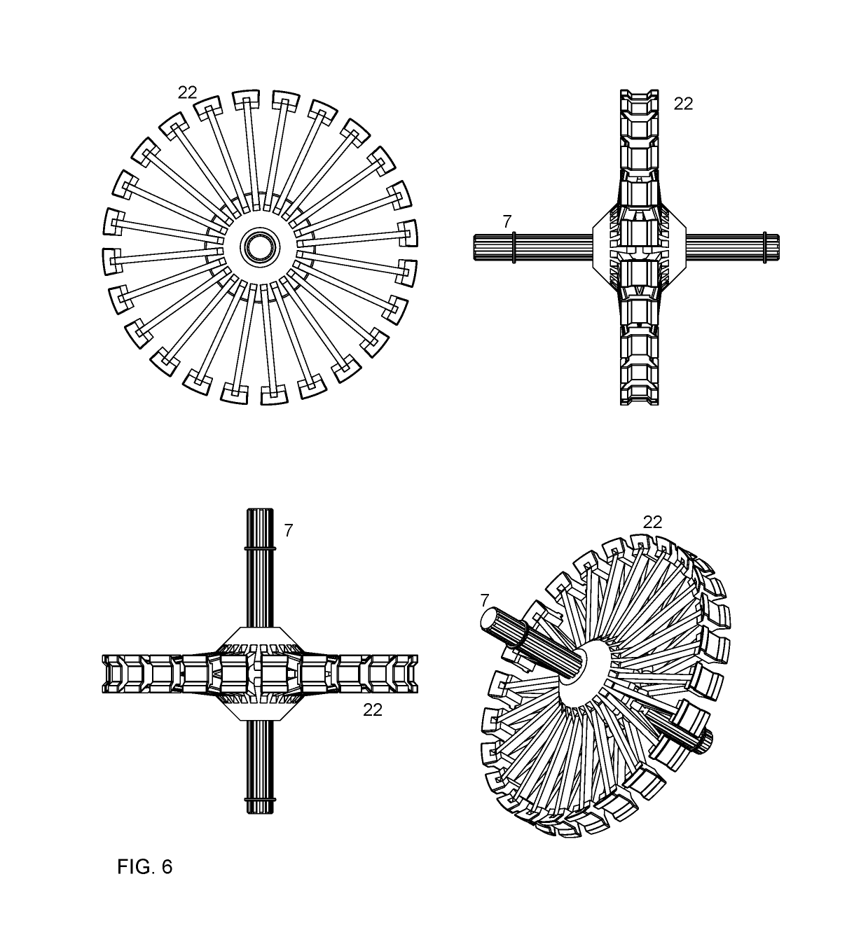

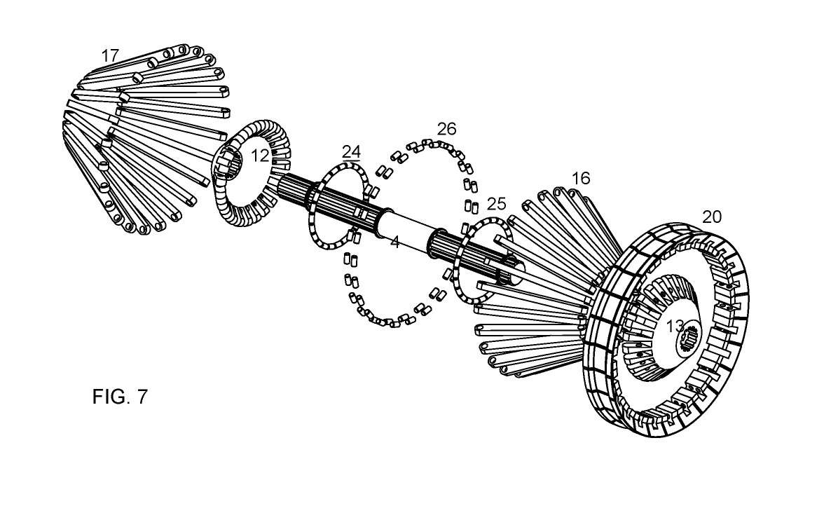

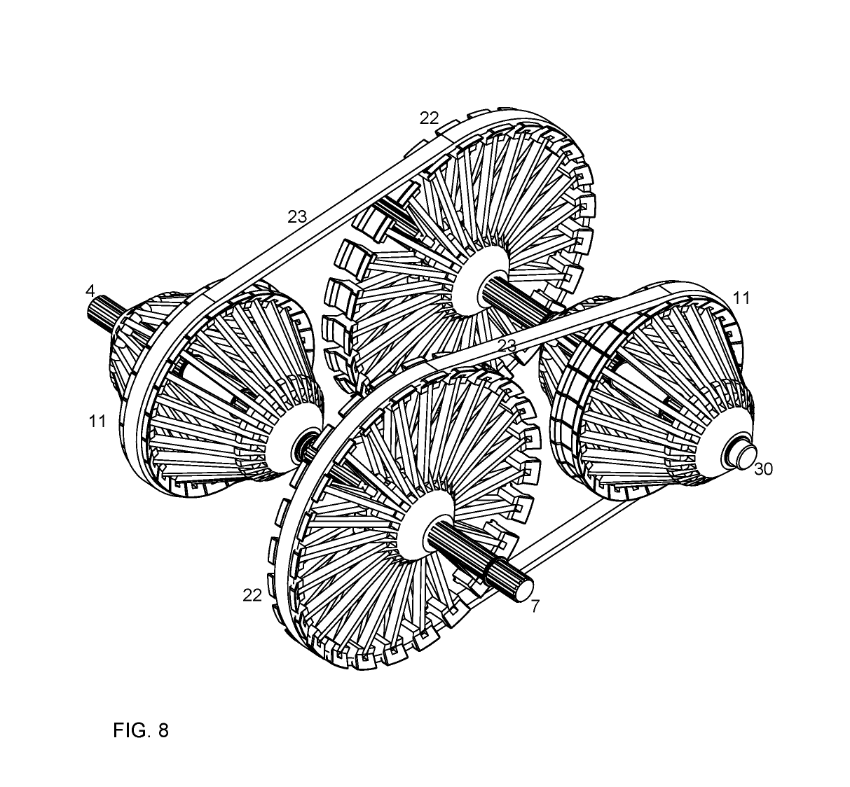

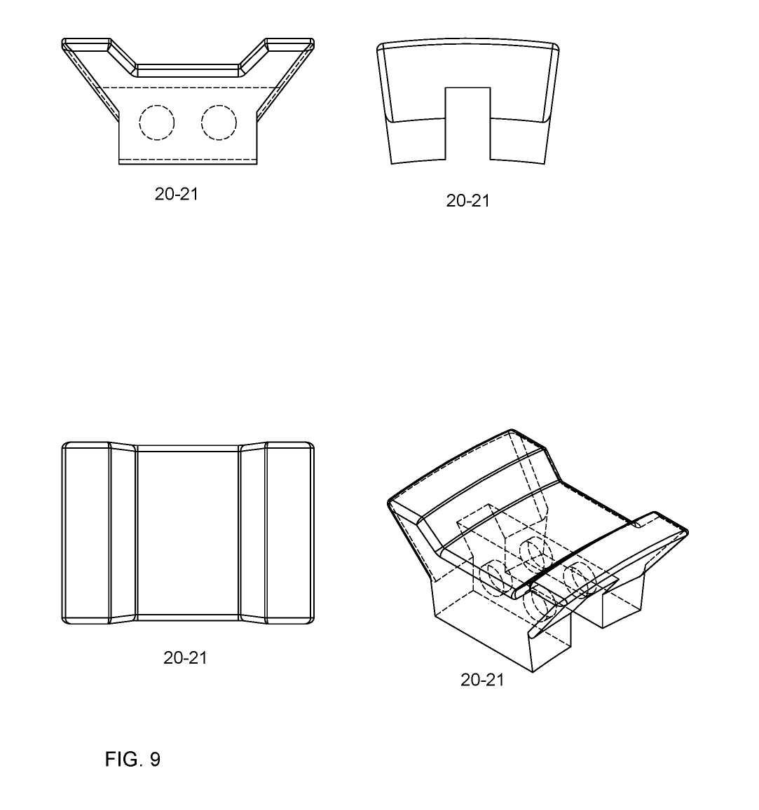

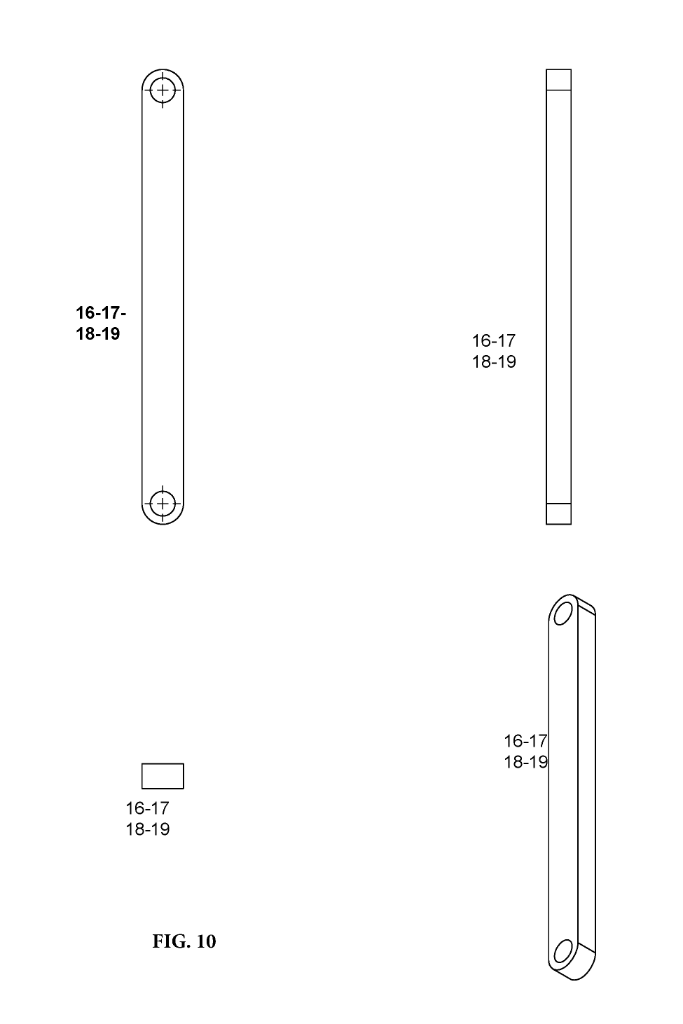

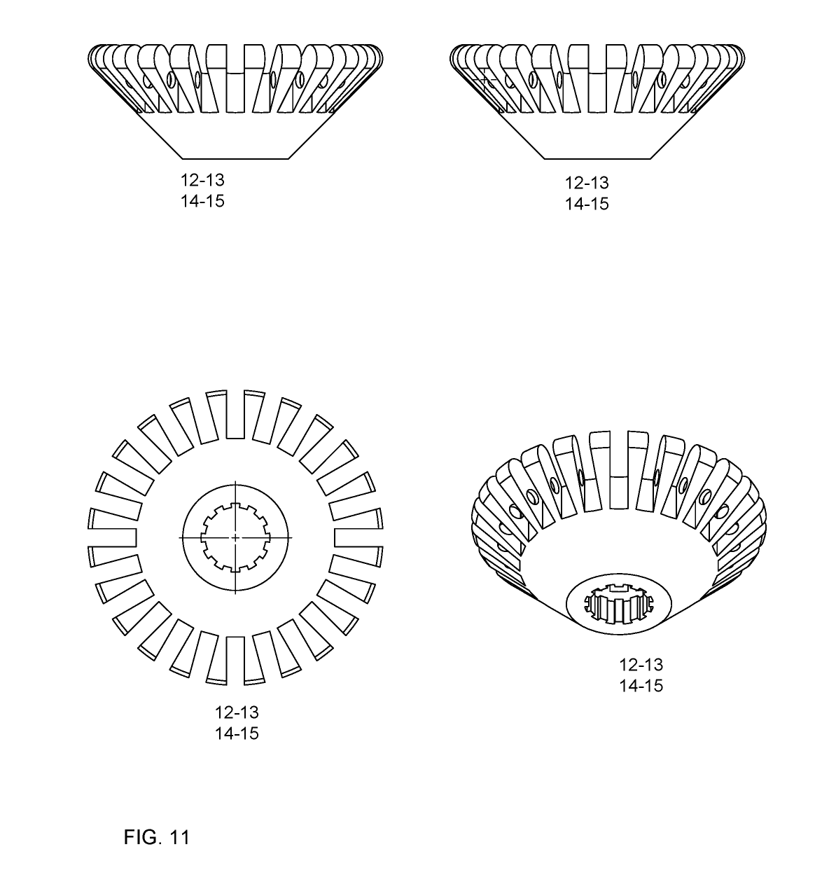

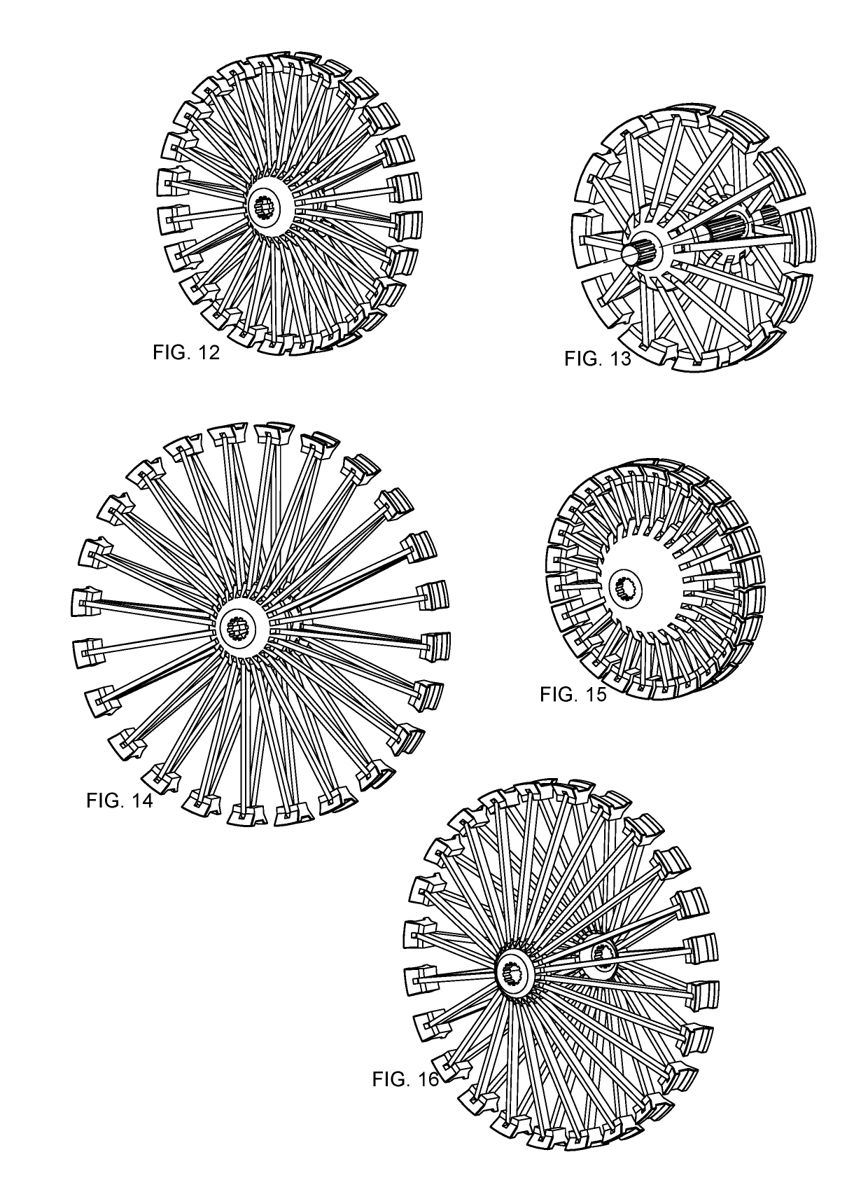

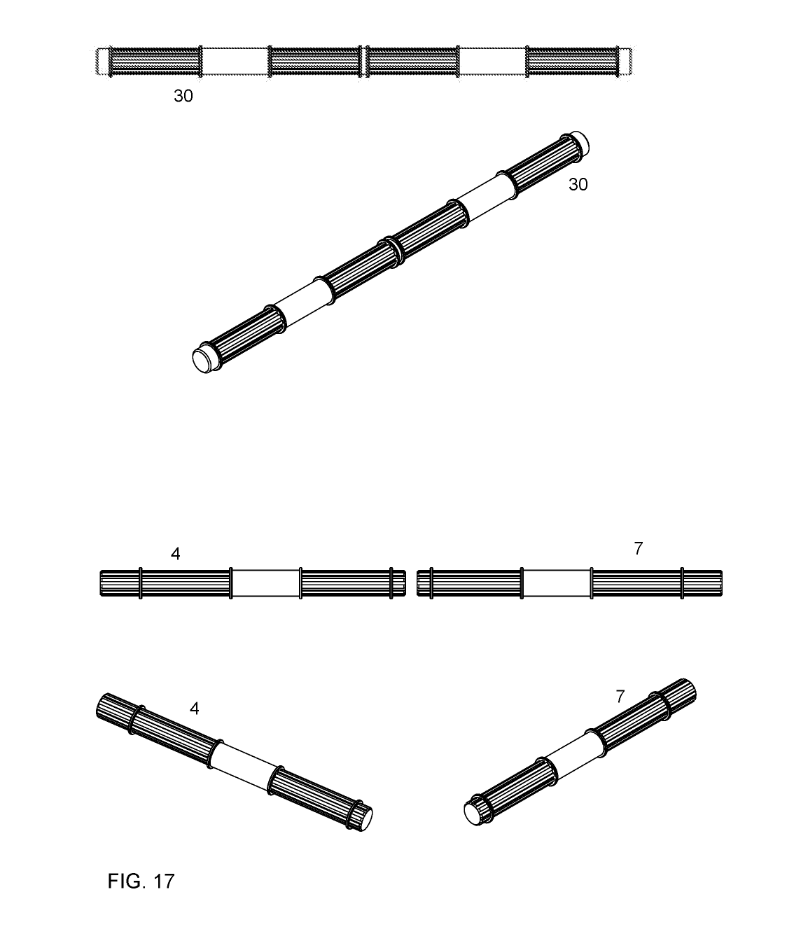

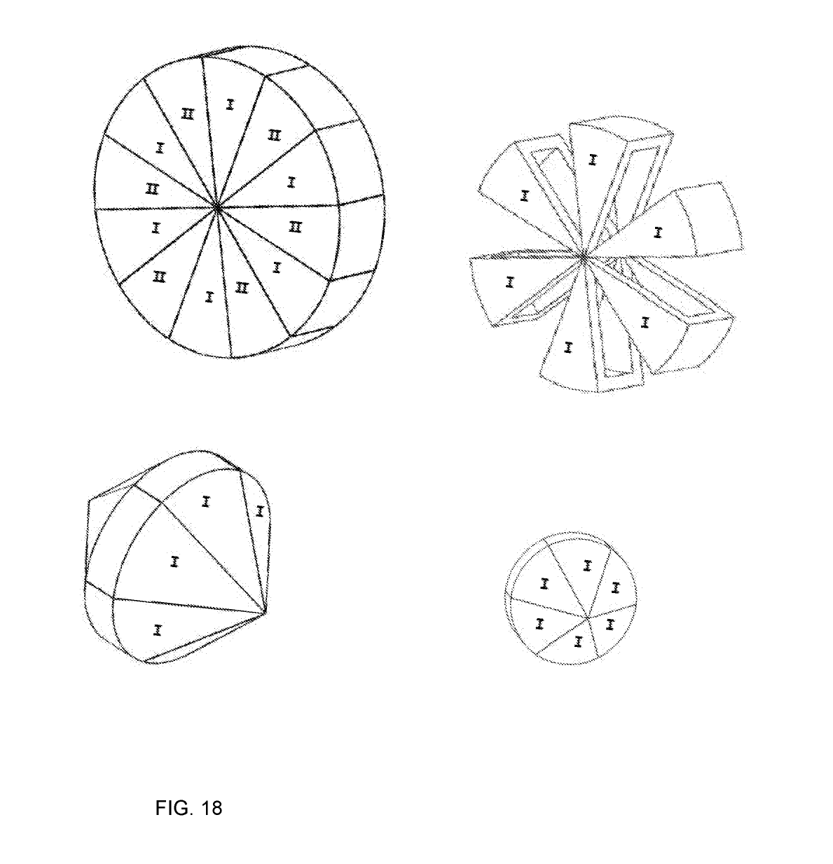

1- A fragmentary pulley. A fragmentary pulley is, in effect, a cylinder which has been divided across its axis into an even number greater than two, creating equal triangular segments based on simple geometric rules. The breaking of the base of these triangular segments and connecting them by hinges render these segments mobile outward on their axis. The said movement on the axis can be reversed within the confine of a specified limit, which in turn, changes the diameter of the cylinder accordingly. We can utilize this concept across a wide range of technologies in rotary machines that are in need of maintaining a variable ratio or vehicular machineries.

2- A continuously variable transmission with a pair of fragmentary pulleys and a plain belt. Based on claim 1 we can contrive a pair of fragmentary pulleys, one at its smallest diameter and the other one at its greatest diameter. We can use a plain belt to transfer the angular speed of the first pulley to the second one.

3- A method according claims 1 and 2 by placing the first pulley on a shaft as the input pulley and the second pulley as output pulley on its shaft, we can transfer the torque certain by means of a belt and thus invent a transmission system that transfers the torque by a constant change in the diameters of our input and output pulleys.

4- Considering claim 3 and the creation of our transmission system, the changeable diameters of the two pulleys allow the system to accrue a variety of ratio.

5- based on claim 4, initially, the input pulley is at its smallest, while the output pulley is at its greatest diameter. At this stage, this system generates greater power and less speed. However, gradually the speed picks up and the input pulley gradually gains in its diameter and the output pulley shrinks. The total circumference of the two pulley remains the same all the time.

6- Based on claim 5, changing diameters in fragmentary pulleys provides the appropriate ratio. There are a myriad of mechanisms such as mechanical, hydraulic, electronic, or pneumatic available to be utilized in order for the fragmentary pulleys to effect the required change. The workings of such systems will bring about the required change based on the torque, driving force, the speed of the ultimate user and other information, configuring the information and constantly send signals to the fragmentary pulleys to change their diameters.

7- Based on claim 6, the command mechanism configures and sends a command signal to the pulleys to bring about the required change. The key characteristics for the mechanism is that the length of the belt remains the same and the change in the diameter of the two fragmentary pulleys, at all times, give us a total circumference that is fixed.

8- Pursuant to claim 7, simultaneously two opposite commands are transmitted, in tandem, to the fragmentary pulley system, which causes one fragmentary pulley to shorten in diameter and the other to extend in diameter. The shortening and lengthening of diameters occur in equal measure always maintaining the length of the belt.

9- To accrue a wide range of ratio change, we can create a compound fragmentary pulley system by daisy chaining two pairs of fragmentary pulley systems, what is key here being to attach the shaft of the output pulley of the first system to the input shaft of the third pulley thus creating a wide range of ratio change.

10- Pursuant to claim 1 the flexibility in design is a distinctive quality of a fragmentary pulley system. We can modify the design to fit different purposes. For example, we can increase the number of triangular shape segments in the cylindrical shape, changing the length of radius in the cylindrical shape, changing the location of the joint in the center of the cylindrical shape.
